(19) United States
(12) Patent Application Publication
(10) Pub. No.: US 2025/0384256 A1
(43) Pub. Date: Dec. 18, 2025

(54) METHOD FOR LOCAL METRIC-BASED MIXED-PRECISION QUANTIZATION APPLICABLE AT COMPILER LEVEL AND APPARATUS THEREFOR

(71) Applicant: Electronics and Telecommunications Research Institute, Daejeon (KR)

(72) Inventors: Je-Min LEE, Daejeon (KR); Yong-In KWON, Daejeon (KR)

(73) Assignee: Electronics and Telecommunications Research Institute, Daejeon (KR)

(21) Appl. No.: 19/240,038

(22) Filed: Jun. 17, 2025

(30) Foreign Application Priority Data
Jun. 18, 2024 (KR) 10-2024-0078949
May 28, 2025 (KR) 10-2025-0069959

(51) Int. Cl. G06N 3/0495

(52) U.S. Cl. CPC G06N 3/0495

(57) ABSTRACT

Disclosed herein are a method for local metric-based mixed-precision quantization applicable at the compiler level and an apparatus for the same. The method includes measuring, by the apparatus, sensitivity of each layer by applying values measured through two local metrics, which are selected by considering compile time, among local metrics for quantization of a neural network model, according to a preset ratio; and performing, by the apparatus, quantization by applying mixed precision to the neural network model based on the sensitivity of each layer.

### CROSS REFERENCE TO RELATED APPLICATIONS

This application claims the benefit of Korean Patent Applications No. 10-2024-0078949, filed Jun. 18, 2024, and No. 10-2025-0069959, filed May 28, 2025, which are hereby incorporated by reference in their entireties into this application.

### BACKGROUND OF THE INVENTION

### 1. Technical Field

The present disclosure relates generally to technology for mixed-precision quantization of a Deep Neural Network (DNN), and more particularly to technology capable of optimizing a model size and computation efficiency and minimizing accuracy loss by dynamically allocating the optimal bit width based on the sensitivity of each layer at the compiler level.

### 2. Description of the Related Art

With the recent increase in the use of Deep Neural Networks (DNNs), the size of models is increasing, which increases the consumption of computing resources and power to efficiently operate models. Especially in embedded systems, there are difficulties in using such large-scale models.

Quantization, which is one of model optimization techniques, is a method of converting parameters of a model to a lower bit width to reduce memory usage and power consumption. However, when all layers are uniformly quantized to the same low bit width, the accuracy of the model is significantly degraded. In order to overcome this problem, a mixed-precision quantization technique, which applies different bit widths depending on the importance of each layer has been proposed. However, the existing mixed-precision quantization technique requires a large amount of data and complex parameter tuning, which makes it difficult to apply in an environment with limited data accessibility or insufficient resources.

### Documents of Related Art

(Patent Document 1) Korean Patent Application Publication No. 10-2023-0102665, published on Jul. 7, 2023 and titled “Method and system for processing deep learning network quantization”.

### SUMMARY OF THE INVENTION

An object of the present disclosure is to provide a new mixed-precision quantization method for reducing the size of a deep neural network, improving computational efficiency, and minimizing accuracy loss.

Another object of the present disclosure is to enable a deep neural network model to be effectively operated even in a resource-limited environment such as an embedded system.

In order to accomplish the above objects, a method for mixed-precision quantization, performed by a mixed-precision quantization apparatus, according to the present disclosure includes measuring sensitivity of each layer by applying values measured through two local metrics, which are selected by considering compile time, among local metrics for quantization of a neural network model, according to a preset ratio; and performing quantization by applying mixed precision to the neural network model based on the sensitivity of each layer.

Here, the two local metrics may correspond to a Signal-to-Quantization Noise Ratio (SQNR) and a Mean Squared Error (MSE).

Here, the sensitivity of each layer may be computed by considering a weight and an activation value.

Here, the sensitivity of each layer may be measured by applying, according to the preset ratio, a first measurement value to which the weight and the SQNR are applied, a second measurement value to which the activation value and the SQNR are applied, a third measurement value to which the weight and the MSE are applied, and a fourth measurement value to which the activation value and the MSE are applied.

Here, performing the quantization may include generating a sensitivity list by sorting layers in descending order of sensitivity based on the sensitivity of each layer; and generating a quantization exclusion list by extracting layers to which quantization is not to be applied based on priority in the sensitivity list.

Here, performing the quantization may comprise applying the mixed precision such that the layers included in the quantization exclusion list, among layers constituting the neural network model, are prevented from being quantized.

Here, performing the quantization may further include performing operator fusion based on a convolution operation, a batch normalization operation, and an activation function.

Here, performing the operator fusion may comprise integrating the batch normalization operation into weights and bias values of the convolution operation when the batch normalization operation is performed after the convolution operation.

Here, performing the operator fusion may comprise substituting the output scale of the activation function with the output scale of the convolution operation.

Here, the first and second measurement values may be measured by applying a gradient of the SQNR.

Also, an apparatus for mixed-precision quantization according to an embodiment of the present disclosure includes a processor for measuring sensitivity of each layer by applying values measured through two local metrics, which are selected by considering compile time, among local metrics for quantization of a neural network model, according to a preset ratio and performing quantization by applying mixed precision to the neural network model based on the sensitivity of each layer; and memory for storing the sensitivity of each layer.

Here, the two local metrics correspond to a Signal-to-Quantization Noise Ratio (SQNR) and a Mean Squared Error (MSE).

Here, the sensitivity of each layer may be computed by considering a weight and an activation value.

Here, the sensitivity of each layer may be measured by applying, according to the preset ratio, a first measurement value to which the weight and the SQNR are applied, a second measurement value to which the activation value and the SQNR are applied, a third measurement value to which the weight and the MSE are applied, and a fourth measurement value to which the activation value and the MSE are applied.

Here, the processor may generate a sensitivity list by sorting layers in descending order of sensitivity based on the sensitivity of each layer and may generate a quantization exclusion list by extracting layers to which quantization is not to be applied based on priority in the sensitivity list.

Here, the processor may apply the mixed precision such that the layers included in the quantization exclusion list, among layers constituting the neural network model, are prevented from being quantized.

Here, the processor may perform operator fusion based on a convolution operation, a batch normalization operation, and an activation function.

Here, the processor may integrate the batch normalization operation into weights and bias values of the convolution operation when the batch normalization operation is performed after the convolution operation.

Here, the processor may substitute the output scale of the activation function with the output scale of the convolution operation.

Here, the first and second measurement values may be measured by applying a gradient of the SQNR.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart illustrating a method for local metric-based mixed-precision quantization applicable at the compiler level according to an embodiment of the present disclosure;

FIG. 2 is a view illustrating an example of a system for local metric-based mixed-precision quantization applicable at the compiler level according to the present disclosure;

FIG. 3 is a view illustrating an example of an algorithm for generating a sensitivity list in a mixed-precision quantization method according to the present disclosure;

FIG. 4 is a flowchart illustrating an example of the operation process of the algorithm illustrated in FIG. 3;

FIG. 5 is a view illustrating an example of an algorithm for application of mixed precision in a mixed-precision quantization method according to the present disclosure;

FIG. 6 is a flowchart illustrating an example of the operation process of the algorithm illustrated in FIG. 5; and

FIG. 7 is a view illustrating an apparatus for local metric-based mixed-precision quantization applicable at the compiler level according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

The present disclosure intends to propose a mixed-precision quantization method that automatically allocates a bit width suitable for each layer of a neural network model using a small amount of data at compile time. According to the present disclosure, the sensitivity of each layer is measured in real time using an operator-specific local metric, and quantization is performed based thereon, whereby it is possible to efficiently reduce memory and power consumption while maintaining the accuracy of the model.

This method provides superior performance in terms of time, the model size, and accuracy, compared to existing methods. Particularly in embedded systems and mobile devices with limited computational resources, this method may optimize the model size and computational efficiency and minimize accuracy loss. It also plays a key role in improving performance and efficiency in applications requiring real-time processing and may expand applicability in neural network optimization and computer science fields.

Here, the mixed-precision determination method proposed in the present disclosure is an algorithm applicable at the compiler level. This method may quickly find a sensitive layer causing a significant decrease in accuracy in the input model at compile time and may apply mixed precision thereto. Therefore, the present disclosure adopts the following three strategies.

First, operations based on O(1) local metrics applicable at compile time are performed without relying on retraining, Signal-to-Quantization Noise Ratio (SQNR) and Mean Squared Error (MSE) are optimally applied to weights and activation values to derive stable local metrics, and a graph-level intermediate representation most suitable for application of mixed precision, among various graph-level intermediate representations modified through operator fusion, is determined and used. Finally, from the perspective of a user, the extent of application of quantization is determined according to the objective, whereby the mixed precision may be determined.

Hereinafter, a preferred embodiment of the present disclosure will be described in detail with reference to the accompanying drawings.

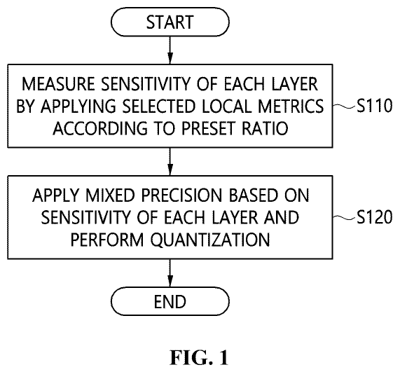

FIG. 1 is a flowchart illustrating a method for local metric-based mixed-precision quantization applicable at the compiler level according to an embodiment of the present disclosure.

Referring to FIG. 1, in the method for local metric-based mixed-precision quantization applicable at the compiler level according to an embodiment of the present disclosure, a mixed-precision quantization apparatus measures sensitivity of each layer by applying values measured through two local metrics according to a preset ratio at step S110, the two local metrics being selected by considering compile time, among local metrics for quantization of a neural network model.

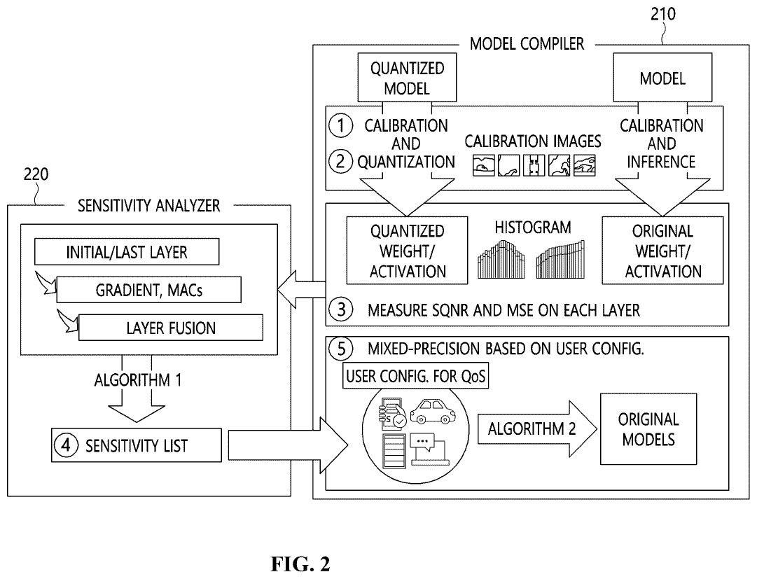

For example, referring to FIG. 2, the present disclosure may be broadly divided into parts corresponding to a model compiler 210 and a sensitivity analyzer 220. That is, the present disclosure may extend and apply a compiler to support mixed precision at the compiler level. Accordingly, when a backend supported by an existing compiler is present, it is easy to apply thereto, and the quantization process for mixed precision may be divided into two stages: calibration and mixed-precision determination.

Specifically, the process for quantization of a model according to the present disclosure may be performed in the following order.

First, the data distribution of weights is checked, and calibration for adjusting the parameters of the model may be performed (\textcircled{1}). At this stage, a histogram of a possible numerical range for the activation of each layer of a neural network is captured and is then stored in a calibration cache. In the beginning, the compiler processes a pretrained model and image input for calibration. Then, a histogram of a tensor value for identifying a possible numerical range for the activation of each layer of the neural network is generated by monitoring execution while inference is being performed.

Subsequently, based on the distribution of the collected data, scale information for quantization is computed, and quantization to the same bit width is performed (\textcircled{2}).

Subsequently, a Signal-to-Quantization Noise Ratio (SQNR) and a Mean Squared Error (MSE) on each layer are measured (\textcircled{3}) using the layer-wise weight and activation tensor values of the original model and the quantized model.

Subsequently, an SQNR gradient value of each layer is computed, and a sensitivity list for quantization is generated through the SQNR gradient and MSE of each layer and operator fusion (\textcircled{4}).

Finally, in terms of Quality of Service (QoS), the mixed precision is determined according to requirements, and a configuration (Config.) file is generated (\textcircled{5}). At this stage, the mixed precision may be applied to each layer based on the sensitivity list set by the sensitivity analyzer 220.

Here, in the present disclosure, it is assumed that the compiler can select whether to apply quantization to each layer.

For example, the overall search range of mixed precision considered in the present disclosure may be computed as follows. First, when two mixed precision levels, B, corresponding to FP32 and INT8, are considered in the present disclosure and when the total number of layers is L, the search space may become B^{L}. When all dependencies are considered, the search space becomes 2⁴⁸ based on ResNet18v1, which is impractical. Therefore, the assumption that the respective layers are independent of each other is also adopted in the present disclosure, as in the previous mixed-precision techniques. In this case, the search space is simplified to BL corresponding to linear complexity, which is more practical.

Through this process, the model compiler 210 may determine the layers to which quantization is not to be applied, maintain 32-bit precision for the determined layer, and perform quantization to 8-bit precision for the remaining layer. Accordingly, it is possible to obtain a quantized model that compensates for degradation in Top-1 accuracy while satisfying the intended use based on QoS.

Here, step S110 may correspond to the process performed by the sensitivity analyzer 220 in FIG. 2.

Here, a sensitivity list may be generated by sorting layers in descending order of sensitivity based on the sensitivity of each layer.

Here, the two local metrics may correspond to a Signal-to-Quantization Noise Ratio (SQNR) and a Mean Squared Error (MSE).

For example, the sensitivity analyzer 220 illustrated in FIG. 2 may simultaneously use the local metrics corresponding to the SQNR and MSE.

Generally, local metrics that can be simply used at compile time include SQNR, MSE, cosine similarity, and the like. Here, in order to compute the local metrics, values output from each layer before/after quantization at the compile step may be stored.

Here, the characteristics of each of SQNR, MSE, and cosine similarity and the method of computing the same are as follows.

First, the SQNR measures the ratio of signal power to quantization noise power, and the higher the measured value, the lower the quantization noise. Here, the SQNR may be computed as shown in Equation (1), and because it focuses on the overall energy ratio, small errors in specific regions may be ignored.

$$S Q N R = 10 {log}_{10} ( \frac{{P}_{s i g n a l}}{{P}_{n o i s e}} ) \qquad ( 1 )$$

Also, the MSE may compute the average of the squared differences between predicted and actual values. Here, the MSE may be computed as shown in Equation (2), and the lower the computed value, the fewer the quantization errors. Also, the MSE may focus on the absolute differences between the actual and predicted values. That is, because it is squared, more weights are assigned to a large error, and a small error may be relatively ignored.

$$M S E = \frac{1}{n} {\sum }_{i = 1}^{n} {( {P}_{s i g n a l} - {P}_{n o i s e} )}^{2} \qquad ( 2 )$$

Finally, the cosine similarity may compute similarity by measuring the angle between two vectors. Here, the cosine similarity may be computed as shown in Equation (3) and it focuses on the direction of the vector without considering the magnitude thereof. The value of the cosine similarity ranges between −1 and 1, and as the value is closer to 1, which indicates that the directions of the two vectors are similar.

Also, the cosine similarity does not consider the magnitude or energy level of a signal. Therefore, information about the overall strength of the signal may be ignored. That is, even if the angles are similar, there may be significant differences in actual values, so there may be a large limitation in evaluating the absolute magnitude of the quantization error.

$$cosine similarity ( A , B ) = \frac{A \cdot B}{‖ A ‖ ‖ B ‖} \qquad ( 3 )$$

Finally, in the present disclosure, the SQNR and the MSE are used together to complement each other.

Here, the SQNR evaluates the overall signal-to-noise ratio, and the MSE analyzes the magnitude and distribution of errors at the individual sample level. Therefore, comprehensive and detailed analysis of quantization errors may be performed.

Here, the sensitivity of each layer may be computed by considering a weight and an activation value.

Here, the sensitivity of each layer may be measured by applying, according to the preset ratio, a first measurement value to which the weight and the SQNR are applied, a second measurement value to which the activation value and the SQNR are applied, a third measurement value to which the weight and the MSE are applied, and a fourth measurement value to which the activation value and the MSE are applied.

In the present disclosure, how to compute the weight and the activation value is explored through experiments so as to compute the optimal SQNR. The considerations may be divided into a part for operator fusion and a part for computing the activation value.

Here, when the SQNR is individually computed for the operator for a convolution operation and the operator for a batch normalization operation, the unique characteristics of each layer may be better reflected, so the difference in sensitivity between layers may be better distinguished. Also, because the number of precision options capable of being individually assigned to each operator is increased, the search space may be expanded, and the optimal precision may be assigned to the layer. Therefore, in the present disclosure, a sensitivity list may be generated in the state in which operator fusion is not performed.

Also, in the case of the activation, the SQNR may vary depending on the input image. Therefore, the SQNR that is computed using an arbitrary dataset and the dataset used for calibration may be analyzed.

For example, because the weight distribution of a DNN model is tailored to the characteristics of the dataset used for calibration, computing the activation SQNR using the calibration dataset allows the SQNR to be distributed across a wider range, and the difference in sensitivity between layers may be better distinguished. Therefore, the SQNR may be measured using the dataset used for calibration, and the measured SQNR may be used.

Here, the first and second measurement values may be measured by applying the gradient of the SQNR.

For example, simply using the SQNR indicator to measure the sensitivity of each layer may be vulnerable to quantization noise that accumulates as it propagates through the layers. Also, the SQNR of individual nodes is insufficient to generate an accurate sensitivity list. Therefore, in the present disclosure, the SQNR gradient may be computed and used to measure sensitivity.

Here, the SQNR gradient may reduce the cumulative quantization noise, and in order to consider the interaction between layers, it may be computed using the SQNR values of adjacent layers.

For example, the SQNR gradient corresponds to relative sensitivity and may be computed as shown in Equation (4):

$$SQNR {Gradient}_{n} = \frac{S Q N {R}_{n + 1} - S Q N {R}_{n}}{{L}_{n + 1} - {L}_{n}} \qquad ( 4 )$$

Here, because the SQNR gradient is a gradient value, the impact of the cumulative noise may be mitigated, and not the value of a single layer but the correlation between adjacent layers may be considered. Also, because the sensitivity of layers is determined based on an increase/decrease in the SQNR gradient, a sensitivity list with better generalization performance than the simple SQNR indicator may be generated.

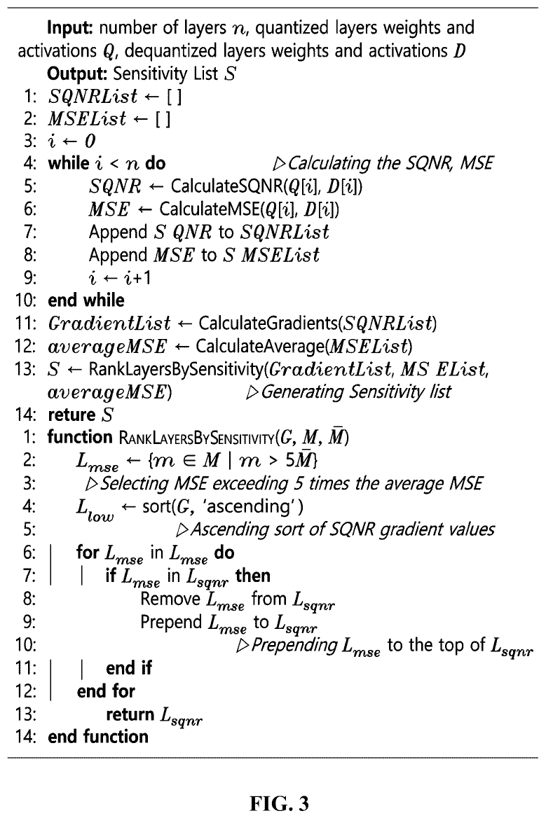

Here, the sensitivity list according to the present disclosure may be generated according to the procedure of algorithm 1 illustrated in FIG. 3.

Referring to FIG. 3, algorithm 1 may be analyzed based on the state of the layers in a DNN model before operator fusion. Also, local metrics may be obtained using a calibration dataset based on which the DNN model can be understood well, and SQNR and MSE, which can be computed within compile time, may be used as the local metrics. Here, the SQNR may be computed for not only weights but also activation tensors in order to sufficiently evaluate sensitivity for all of the operators of the DNN model. Also, the computed SQNR may be converted into an indicator called a SQNR gradient in order to reduce the impact of cumulative quantization noise and to understand the interaction between layers. Finally, a sensitivity list may be generated by combining the SQNR gradients of the weights and activation tensors with the MSE metric, which is advantageous to finding a layer with large quantization noise.

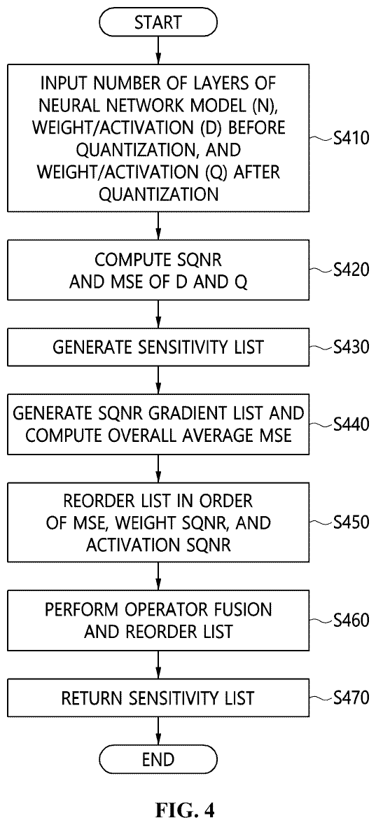

Hereinafter, the process of generating a sensitivity list will be described in more detail with reference to FIG. 4.

Referring to FIG. 4, first, in order to generate a sensitivity list S for quantization, the number of layers of a DNN model (n), weight/activation tensor values D of each layer before quantization, and weight/activation tensor values Q of each layer after quantization are received at step S410.

Subsequently, an SQNR and an MSE, which are local metrics, are computed using D and Q of each layer at step S420, and a sensitivity list is generated by matching the DNN model layer and the local metrics at step S430.

Subsequently, a SQNR gradient list is generated using the SQNR values of the previous/next nodes, and the overall average MSE is computed using the MSE value of each layer at step S440.

Subsequently, layers having an MSE value that is significantly higher than the overall average MSE are found using the RankLayerBySensitivity ( ) function, and the layer names thereof are recorded at the top of the sensitivity list such that the layers are preferentially dequantized. Subsequently, the weight and activation SQNR gradient lists are sorted in ascending order, and the sorted two lists are combined for the weight and activation values and reordered at step S450.

Here, because the SQNR gradient better reflects the layer sensitivity of the model, the sensitivity list may be sorted by giving more gain to the weight SQNR than the activation SQNR.

Subsequently, when operators that can be fused are adjacent in the list, the list is reordered by adjusting the positions of the operators to enable operator fusion at step S460, the sorted layer names are recorded in the sensitivity list, and the finally generated sensitivity list is returned at step S470.

Also, in the method for local metric-based mixed-precision quantization applicable at the compiler level according to an embodiment of the present disclosure, the mixed-precision quantization apparatus performs quantization by applying mixed precision to the neural network model based on the sensitivity of each layer at step S120.

Here, layers to which quantization is not to be applied are extracted based on the priority in the sensitivity list, whereby a quantization exclusion list may be generated.

Here, the mixed precision may be applied such that the layers included in the quantization exclusion list, among the layers constituting the neural network model, are prevented from being quantized.

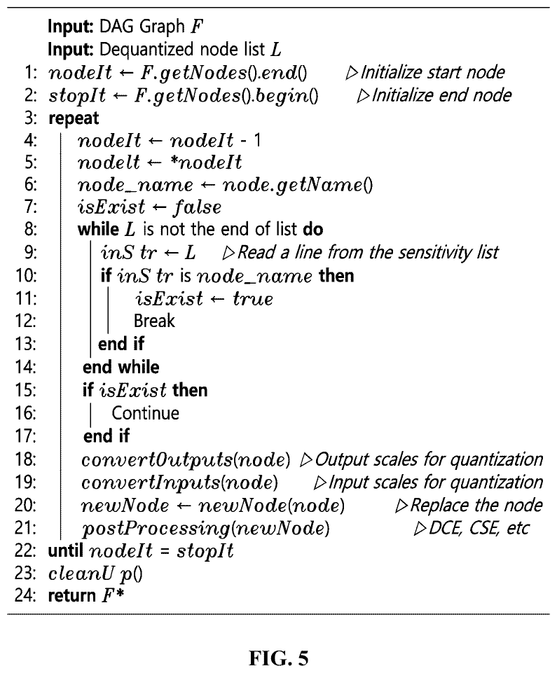

Here, the mixed precision according to the present disclosure may be determined according to the procedure of algorithm 2 illustrated in FIG. 5.

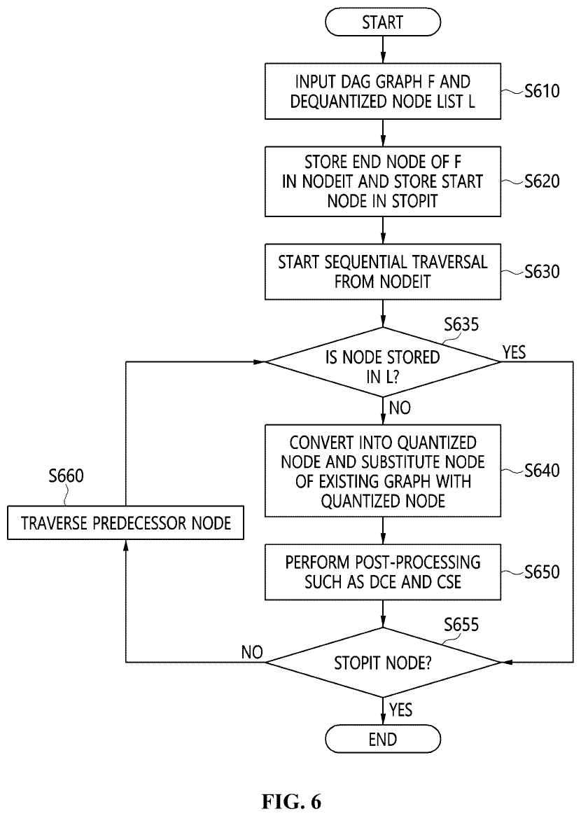

Hereinafter, the process of applying mixed precision at the graph intermediate representation level generated by a compiler will be described in more detail with reference to FIGS. 5 and 6.

Referring to FIG. 6, first, a DAG graph F and a dequantized node list L are input to the algorithm at step S610.

Here, the dequantized node list, L, may contain the names of the layers to which quantization is not to be applied depending on the level of quantization set by a user based on the sensitivity list. Therefore, quantization is not applied to the layers recorded in the dequantization node list, L.

Subsequently, as shown in lines 1 to 2 in FIG. 5, pointers corresponding to an end node and a start node in the input DAG graph, F, are allocated and stored in nodeIt and stopIt at step S620.

Subsequently, sequential traversal starts from nodeIt, which is the end node of the input graph, at step S630, and whether the current node is a node stored in the dequantized node list, L, may be determined at step S635, as shown in lines 3 to 22 in FIG. 5.

When it is determined at step S635 that the current node is not a node stored in the dequantized node list, L, the current node is converted into a quantized node and replaces the existing graph node at step S640.

After the graph node is converted into the quantized node, basic compiler optimization such as Dead Code Elimination (DCE) and Common Subexpression Elimination (CSE) are performed as postprocessing to eliminate unnecessary parts from the existing graph at step S650.

Here, the part matching L is specifically described in lines 8 to 14 in FIG. 5.

Subsequently, whether the current node is stopIt, which is the start node of the input graph, is determined at step S655, and when the current node is stopIt, the algorithm may be terminated.

Conversely, when it is determined at step S655 that the current node is not stopIt, traversal may be continuously performed by sequentially moving to the predecessor node one by one in the input graph at step S660.

Also, when it is determined at step S635 that the current node is a node stored in the dequantized node list, L, step S655 may be performed without applying quantization thereto.

Through the above-described process, the quantized DAG Graph, F*, may be finally output.

Here, operator fusion may be performed based on a convolution operation, a batch normalization operation, and an activation function.

In the present disclosure, sensitivity analysis is performed in the state in which operator fusion is not performed, but when applying mixed precision, it may be performed in a graph form in which fusion is performed as much as possible.

That is, in the case of the sensitivity list, the forms of layers before operator fusion are considered for precise analysis, but when applying mixed precision, operator fusion is considered for accuracy and execution speed optimization.

For example, in the present disclosure, fusion of a convolution operation and a batch normalization operation and fusion of a convolution operation and a ReLU activation function may be considered.

Here, when the batch normalization operation is performed after the convolution operation, the batch normalization operation may be integrated into the weight and bias values of the convolution operation.

For example, Equation (5) represents the value of the i-th layer that is generated when the convolution operation and the batch normalization operation are sequentially executed.

$$\begin{matrix}{Y}_{i} = {γ}_{i} ( \frac{c o n {v ( x )}_{i} - {μ}_{i}}{\sqrt{{σ}_{i}^{2}}} ) + {β}_{i} , {conv ( x )}_{i} = {W}_{i} * {X}_{i} + {B}_{i} \\ {Y}_{i} = {γ}_{i} ( \frac{{W}_{i} * {X}_{i} + {B}_{i} - {μ}_{i}}{\sqrt{{σ}_{i}^{2}}} ) + {β}_{i} \\ {Y}_{i} = {δ}_{i} ( {W}_{i} * {X}_{i} ) + ( {δ}_{i} {B}_{i} - {δ}_{i} {μ}_{i} + {β}_{i} ) , {δ}_{i} = \frac{{γ}_{i}}{\sqrt{{σ}_{i}^{2}}} \\ {Y}_{i} = {A}_{i} x {X}_{i} + {C}_{i} , {A}_{i} = {δ}_{i} * {W}_{i} , {C}_{i} \\ {Y}_{i} = ( {δ}_{i} {B}_{i} - {δ}_{i} {μ}_{i} + {β}_{i} )\end{matrix} \qquad ( 5 )$$

Here, in Equation (5), conv (x) denotes a convolution operation for input x, and may be defined by matrix multiplication of weights W and input X and addition of biases B. Also, γ and β may denote weights corresponding to the batch normalization operation. Here, when the operation in Equation (5) is expanded and substituted, the batch normalization operation is integrated into weights A and biases C of the transformed convolution operation, resulting in computational benefits when executed.

Such optimization of operator fusion is a method of performing a constant operation in advance at compile time, regardless of the target hardware, so it always has a benefit in terms of inference delay.

Here, the output scale of the activation function may be substituted with the output scale of the convolution operation.

For example, Equation (6) represents fusion of a convolution operation and an activation function ReLU.

$$R e L U ( c o n {v ( x )}_{i} ) = max ( 0 , {W}_{i} * {X}_{i} + {B}_{i} ) \qquad ( 6 )$$

Here, in Equation (6), Wᵢ, Xᵢ, and Bᵢ may denote filter weights, input data, and a bias, respectively, and max (0, ·) may denote the ReLU function.

Here, when the convolution operation and the ReLU are fused, it is important to maintain the scaling factor for quantization such that accuracy is improved. To this end, operator fusion may substitute the output scale of the ReLU with the output scale of the convolution operation. In this case, there is no need to maintain the output scale of the convolution operation, and the quantization process for the output value of the convolution operation and the input value of the ReLU is eliminated, which improves the overall model accuracy and reduces the overall computational overhead.

Here, the scale substitution and accuracy improvement may be explained as shown in Equation (7).

$$\begin{matrix}{y}_{fp 32} = {S}_{x} {S}_{w} ( {\sum }_{n = 1}^{N} ( {x}_{i}^{n} {w}_{i}^{n} ) ) \\ {y}_{i 8} = ROUND ( \frac{{S}_{x} {S}_{w}}{{S}_{y}} {\sum }_{n = 1}^{N} ( {x}_{i}^{n} {w}_{i}^{n} ) )\end{matrix} \qquad ( 7 )$$

Here, Equation (7) simplifies a part of the convolution operation by omitting the bias, and it represents the process of multiplying the quantized feature map xᵢ₈ by quantized wᵢ₈ and performing dequantization in order to obtain a real number y_{fp32}. This may be represented as consecutive operations of the convolution operation and ReLU, as shown in Equation (8).

$$\begin{matrix}{a}_{i 8} = \frac{{S}_{y}}{{S}_{a}} F ( ROUND ( \frac{{S}_{x} {S}_{w}}{{S}_{y}} {\sum }_{n = 1}^{N} ( {x}_{i}^{n} {w}_{i}^{n} ) ) ) \\ {a}_{i 8} = \frac{{S}_{y}}{{S}_{a}} MAX ( 0 , ROUND ( \frac{{S}_{x} {S}_{w}}{{S}_{y}} {\sum }_{n = 1}^{N} ( {x}_{i}^{n} {w}_{i}^{n} ) ) ) \\ {a}_{i 8} = MAX ( 0 , ROUND ( \frac{{S}_{x} {S}_{w}}{{S}_{y}} {\sum }_{n = 1}^{N} ( {x}_{i}^{n} {w}_{i}^{n} ) ) ) \\ {a}_{i 8} = MAX ( 0 , ROUND ( \frac{{y}_{fp 32}}{{S}_{a}} ) )\end{matrix} \qquad ( 8 )$$

Here, referring to Equation (8), it can be seen that S_{y} is eliminated.

Here, S_{y} corresponds to the output scale of the convolution operation substituted by the ReLU. Also, because the input scale is always equal to or greater than the output scale according to the characteristics of ReLU, Sₐ<S_{y} may hold. That is, when Sₐ<S_{y} holds, the accuracy may be improved by operator fusion. In this case, quantization to the scale Sₐ, which more accurately reflects the dynamic output of the ReLU, is performed only once, so precision loss may be reduced.

Using the above-described mixed-precision quantization method, the following various effects may be expected.

First, the optimal bit width is determined for each layer of a neural network model, whereby it is possible to maintain or improve quantization accuracy while minimizing information loss that can occur during the process of conversion to a lower bit width. This may significantly improve the performance of the model, compared to the uniform quantization method.

Also, compared to existing models, memory usage and power consumption are significantly reduced, so application to embedded systems and mobile devices is possible.

Also, a model may be optimized and distributed for a short period of time without the need for hyperparameter tuning, and consumption of time and resources may be significantly reduced.

Also, data loss may be minimized while reducing a quantization-dequantization process, and inference time may be reduced. Specifically, the time taken to generate a sensitivity list may be reduced by about 99.99%, compared to existing methods, and high efficiency may be achieved in terms of model compression ratio and accuracy.

Also, more accurate measurement is possible by utilizing more information in a large-scale model, which may enable more effective quantization performance. This approach may achieve efficient memory usage and fast processing speed while maintaining high performance in real-world applications.

Consequently, the present disclosure is innovative technology that significantly improves the efficiency and practicality of a DNN model, and may provide significant advantages especially to applications in environments with limited data accessibility or insufficient hardware resources.

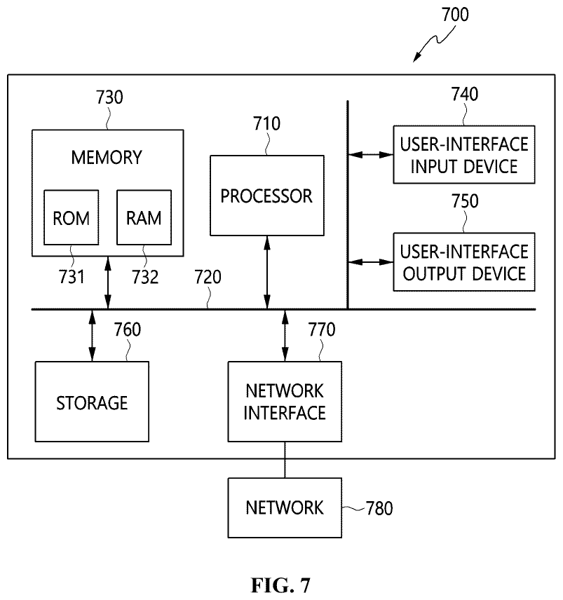

FIG. 7 is a view illustrating an apparatus for local metric-based mixed-precision quantization applicable at the compiler level according to an embodiment of the present disclosure.

Referring to FIG. 7, an apparatus for mixed-precision quantization according to an embodiment of the present disclosure may be implemented in a computer system including a computer-readable recording medium. As illustrated in FIG. 7, the computer system 700 may include one or more processors 710, memory 730, a user input device 740, a user output device 750, and storage 760, which communicate with each other via a bus 720. Also, the computer system 700 may further include a network interface 770 connected to a network 780. The processor 710 may be a central processing unit or a semiconductor device for executing processing instructions stored in the memory 730 or the storage 760. The memory 730 and the storage 760 may be any of various types of volatile or nonvolatile storage media. For example, the memory may include ROM 731 or RAM 732.

Accordingly, an embodiment of the present disclosure may be implemented as a non-transitory computer-readable medium in which methods implemented using a computer or instructions executable in a computer are recorded. When the computer-readable instructions are executed by a processor, the computer-readable instructions may perform a method according to at least one aspect of the present disclosure.

The processor 710 measures sensitivity of each layer by applying values measured through two local metrics, which are selected by considering compile time, among local metrics for quantization of a neural network model, according to a preset ratio.

Here, the two local metrics may correspond to a Signal-to-Quantization Noise Ratio (SQNR) and a Mean Squared Error (MSE).

Here, the sensitivity of each layer may be computed by considering a weight and an activation value.

Here, the sensitivity of each layer may be measured by applying, according to the preset ratio, a first measurement value to which the weight and the SQNR are applied, a second measurement value to which the activation value and the SQNR are applied, a third measurement value to which the weight and the MSE are applied, and a fourth measurement value to which the activation value and the MSE are applied.

Here, the first and second measurement values may be measured by applying a gradient of the SQNR.

Also, the processor 710 performs quantization by applying mixed precision to the neural network model based on the sensitivity of each layer.

Here, based on the sensitivity of each layer, a sensitivity list may be generated by sorting the layers in descending order of sensitivity, and a quantization exclusion list may be generated by extracting layers to which quantization is not to be applied based on priority in the sensitivity list.

Here, the mixed precision may be applied such that the layers included in the quantization exclusion list, among the layers constituting the neural network model, are prevented from being quantized.

Here, operator fusion may be performed based on a convolution operation, a batch normalization operation, and an activation function.

Here, when the batch normalization operation is performed after the convolution operation, the batch normalization operation may be integrated into weights and bias values of the convolution operation.

Here, the output scale of the activation function may be substituted with the output scale of the convolution operation.

Content related to the operation of the processor 710 has been described in detail with reference to FIG. 1, so a description thereof will be omitted.

The memory 730 stores the sensitivity of each layer.

Also, the memory 730 stores various kinds of information generated in the above-described apparatus for mixed-precision quantization according to an embodiment of the present disclosure.

According to an embodiment, the memory 730 may separate from the apparatus for mixed-precision quantization, and may support the function for local metric-based mixed-precision quantization applicable at the compiler level. Here, the memory 730 may operate as separate mass storage, and may include a control function for performing operations.

Meanwhile, the apparatus for mixed-precision quantization includes memory installed therein, whereby information may be stored therein. In an embodiment, the memory is a computer-readable medium. In an embodiment, the memory may be a volatile memory unit, and in another embodiment, the memory may be a nonvolatile memory unit. In an embodiment, the storage device is a computer-readable medium. In different embodiments, the storage device may include, for example, a hard-disk device, an optical disk device, or any other kind of mass storage device.

Through the above-described apparatus for mixed-precision quantization, information loss that can occur in a quantization process for converting the parameters of a DNN model to a lower bit width may be minimized, and the accuracy may be maintained or improved.

Also, the sensitivity of a DNN model may be quickly and efficiently evaluated during compile time, and an appropriate bit width may be automatically allocated.

Also, memory usage and power consumption are significantly reduced, whereby a quantization model that can be suitably used for embedded systems and mobile devices may be provided.

Also, data loss may be minimized while reducing a quantization-dequantization process, and inference time may be reduced.

Also, more accurate measurement may be enabled using more information in a large-scale model, and effective quantization performance may be achieved.

According to the present disclosure, information loss that may occur in the quantization process of converting parameters of a DNN model to a lower bit width may be minimized, and the accuracy may be maintained or improved.

Also, the present disclosure may quickly and efficiently evaluate the sensitivity of a DNN model during compile time and automatically allocate an appropriate bit width.

Also, the present disclosure may provide a quantization model that can be suitably used in embedded systems and mobile devices by significantly reducing memory usage and power consumption.

Also, the present disclosure may reduce the quantization-dequantization process, minimize data loss, and reduce inference time.

Also, the present disclosure enables more accurate measurement by utilizing more information in a large-scale model and enables effective quantization performance.

As described above, the method for local metric-based mixed-precision quantization applicable at the compiler level and the apparatus for the same according to the present disclosure are not limitedly applied to the configurations and operations of the above-described embodiments, but all or some of the embodiments may be selectively combined and configured, so the embodiments may be modified in various ways.

What is claimed is:

1. A method for mixed-precision quantization, performed by a mixed-precision quantization apparatus, comprising:
measuring sensitivity of each layer by applying values measured through two local metrics, which are selected by considering compile time, among local metrics for quantization of a neural network model, according to a preset ratio; and
performing quantization by applying mixed precision to the neural network model based on the sensitivity of each layer.

2. The method of claim 1, wherein the two local metrics correspond to a Signal-to-Quantization Noise Ratio (SQNR) and a Mean Squared Error (MSE).

3. The method of claim 2, wherein the sensitivity of each layer is computed by considering a weight and an activation value.

4. The method of claim 3, wherein the sensitivity of each layer is measured by applying, according to the preset ratio, a first measurement value to which the weight and the SQNR are applied, a second measurement value to which the activation value and the SQNR are applied, a third measurement value to which the weight and the MSE are applied, and a fourth measurement value to which the activation value and the MSE are applied.

5. The method of claim 4, wherein performing the quantization comprises
generating a sensitivity list by sorting layers in descending order of sensitivity based on the sensitivity of each layer; and
generating a quantization exclusion list by extracting layers to which quantization is not to be applied based on priority in the sensitivity list.

6. The method of claim 5, wherein performing the quantization comprises applying the mixed precision such that the layers included in the quantization exclusion list, among layers constituting the neural network model, are prevented from being quantized.

7. The method of claim 5, wherein performing the quantization further comprises performing operator fusion based on a convolution operation, a batch normalization operation, and an activation function.

8. The method of claim 7, wherein performing the operator fusion comprises integrating the batch normalization operation into weights and bias values of the convolution operation when the batch normalization operation is performed after the convolution operation.

9. The method of claim 7, wherein performing the operator fusion comprises substituting an output scale of the activation function with an output scale of the convolution operation.

10. The method of claim 4, wherein the first and second measurement values are measured by applying a gradient of the SQNR.

11. An apparatus for mixed-precision quantization, comprising:
a processor for measuring sensitivity of each layer by applying values measured through two local metrics, which are selected by considering compile time, among local metrics for quantization of a neural network model, according to a preset ratio and performing quantization by applying mixed precision to the neural network model based on the sensitivity of each layer; and
memory for storing the sensitivity of each layer.

12. The apparatus of claim 11, wherein the two local metrics correspond to a Signal-to-Quantization Noise Ratio (SQNR) and a Mean Squared Error (MSE).

13. The apparatus of claim 12, wherein the sensitivity of each layer is computed by considering a weight and an activation value.

14. The apparatus of claim 13, wherein the sensitivity of each layer is measured by applying, according to the preset ratio, a first measurement value to which the weight and the SQNR are applied, a second measurement value to which the activation value and the SQNR are applied, a third measurement value to which the weight and the MSE are applied, and a fourth measurement value to which the activation value and the MSE are applied.

15. The apparatus of claim 11, wherein the processor generates a sensitivity list by sorting layers in descending order of sensitivity based on the sensitivity of each layer and generates a quantization exclusion list by extracting layers to which quantization is not to be applied based on priority in the sensitivity list.

16. The apparatus of claim 15, wherein the processor applies the mixed precision such that the layers included in the quantization exclusion list, among layers constituting the neural network model, are prevented from being quantized.

17. The apparatus of claim 15, wherein the processor performs operator fusion based on a convolution operation, a batch normalization operation, and an activation function.

18. The apparatus of claim 17, wherein the processor integrates the batch normalization operation into weights and bias values of the convolution operation when the batch normalization operation is performed after the convolution operation.

19. The apparatus of claim 17, wherein the processor substitutes an output scale of the activation function with an output scale of the convolution operation.

20. The apparatus of claim 14, wherein the first and second measurement values are measured by applying a gradient of the SQNR.
